(19) United States
(12) Patent Application Publication
(10) Pub. No.: US 2012/0035655 A1
(43) Pub. Date: Feb. 9, 2012

(54) Infant Feeder and Pacifier

(76) Inventor: Christine A. Trocki, El Cajon, CA (US)

(21) Appl. No.: 13/205,016

(22) Filed: Aug. 8, 2011

Related U.S. Application Data
(60) Provisional application No. 61/401,119, filed on Aug. 9, 2010.

(51) Int. Cl. A61J 17/00; A61J 9/08; A61J 9/00

(52) U.S. Cl. 606/236; 215/11.4; 215/11.6

(57) ABSTRACT

This invention is a dual function suckling device. In the first configuration it operates as a small feeding bottle. In the second configuration it operates as a pacifier. It bridges the gap between regular size bottles and pacifiers. This device comprises: a bottle, a plug, and a nipple assembly having a mouth-guard and a cylindrical base equipped with a sealing ring. The cylinder base is configured to be either attached to the bottle, thereby allowing the device to operate as a feeder or stopped up by the plug, thereby allowing the device to operate as a pacifier. Variations of this design include adding a protective cap.

### FIELD OF THE INVENTION

This invention relates to baby bottles and pacifiers. This invention claims the benefit of U.S. Provisional Application 61/401,119, titled, “Infant Feeder/Pacifier” filed on Aug. 9 2010 and which is hereby incorporated by reference. Applicant claims priority pursuant to 35 U.S.C. Par 119(e)(i).

### INCORPORATION BY REFERENCE

The following patent applications have been incorporated by reference: Provisional U.S. Application with application No. 61/401,119 by Trocki, U.S. Pat. No. 3,145,867 by Roberts et al., U.S. Pat. No. 5,531338 by Sklar, U.S. Pat. No. 5,316,160 by Cautereels, U.S. Pat. No. 5,263,599 by Sklar, U.S. Pat. No. 4,778068 by Kohus, U.S. Pat. No. 4,703,863 by Kohus, U.S. Pat. No. 4,676,387 by Stephenson et al., U.S. Pat. No. 5,700,279 by Blando, U.S. Pat. No. 7,753,886 by Vath et al., U.S. Pat. No. 6,547,808 by Tuckey et al., U.S. Pat. No. 5,514,142 by Dean-Homolka, U.S. Pat. No. 5,662,684 by Caso, US patent application 20060155331 by Bohmer, and US application 20070027479 by Carter.

### BACKGROUND

From birth, an infant has a natural sucking instinct or urge. This phenomenon is essential for his survival, for it allows him to feed from the mothers' breast following birth. This urge is independent of the actual feeding need but it may be indistinguishable to the parent from the feeding need. When a baby is crying a parent has the option of giving the infant either a pacifier or a nursing bottle. If the child is hungry and receives the pacifier, he becomes more frustrated. If the child needs to be pacified and receives the bottle, he may suck a small amount and reject the rest. Most of the bottle content will then have to be discarded. Often the child needs a little snack and a small bottle is sufficient.

The prior art does not adequately solve the above problems as can be seen by reference to the following U.S. Pat. Nos. 3,145,867, 4,676,387, 4,703,863, 4,778,068, 5,263,599, 5,316,160, 5,531,338, 6,547,808, and 5,700,279.

There is a need for a suckling device in a small format to provide low dose snacks between scheduled feedings. There is also a need to combine the function of baby bottle and pacifier. There is also a need to provide a light weight suckling device that does not have to be held either by the parent or by the child. There is also a need to provide a feeding device equipped with a mouth guard. Furthermore there is also a need for a feeding or pacifying device equipped with a protective cap over the nipple, to prevent leakage and keep the nipple clean.

A fuller understanding of the present invention will be discerned by those having ordinary skill in the art when the following detailed description of the best mode contemplated for practicing the invention has been read in conjunction with the accompanying drawings.

### BRIEF DESCRIPTION OF THE DRAWINGS

FIG. 1 is an exploded bottom perspective view of the infant feeder.

FIG. 2 is an exploded side view of the infant feeder.

FIG. 3 is an exploded top perspective view of the infant feeder.

FIG. 4 is an exploded side view of the infant feeder from another angle.

FIG. 5 is a top perspective view of the nipple/mouth guard.

FIG. 6 is a top perspective view of the bottle.

FIG. 7 is an exploded top perspective view of the infant pacifier.

FIG. 8 is an exploded side view of the infant pacifier.

FIG. 9 is an exploded bottom perspective view of the infant pacifier.

FIG. 10 is an exploded side view of the infant pacifier from another angle.

FIG. 11 is a perspective view of the bottom of the blocking plug for the infant pacifier.

FIG. 12 shows the nipple assembly with a seal configured to prevent leaks of liquid.

FIG. 13 shows the all the parts of the invention including the bottle 1, the mouth-guard assembly 4, the protective cap 6 and the plug 7.

### SUMMARY

This invention is a dual function suckling device. In the first configuration it operates as a small feeding bottle. In the second configuration it operates as a pacifier. It bridges the gap between regular size bottles and pacifiers. This device comprises:
1) a bottle with a male-threaded top opening;
2) a plug with a male thread;
3) A nipple assembly comprising a nipple, a mouth-guard and a cylindrical base. The base is female threaded at its bottom and includes a sealing ring allowing it to be attached to the bottle or to the plug. The nipple is in fluid communication through the cylindrical base, with the bottle, allowing liquid to pass from the bottle to the nipple. The attachment mechanism between these elements needs to be very secure to prevent the parts from coming apart and posing a swallowing hazard to the child. For example the mouth-guard, cylindrical base, sealing ring and nipple could be manufactured as one single piece.

The device operates as a feeder when the cylindrical base holds a bottle and it operates as a pacifier when the cylindrical base is stopped by the plug.

As a possible variation, a protective cap can be added, that fits on top of the nipple assembly.

The bottle is relatively small ranging from one ounce to two ounces, bridging the gap between regular feeder and pacifier. This small size has several advantages:
1) It is light in weight, allowing feeding of mother's milk or formula without the mother or caretaker holding the bottle.
2) It allows small snacks and the administration of medicines.
3) It simplifies the feeding process.
4) It reduces wastage.

The device can also be converted to a regular sized feeder by attaching a standard size bottle to the nipple assembly.

The invention also covers a method of feeding or pacifying infants four months or younger. This method comprises:
1) if the infant is to be fed, filling the bottle with nutrient, attaching the bottle to the nipple assembly and administrating the suckling device to the infant;
2) if the infant is to be pacified, attaching the plug to the nipple assembly and administrating the suckling device to the infant.

### DETAILED DESCRIPTION OF THE INVENTION

Before explaining the disclosed embodiment of the present invention in detail it is to be understood that the invention is not limited in its application to the details of the particular arrangement shown since the invention is capable of other embodiments. Also, the terminology used herein is for the purpose of description and not of limitation. It is thought that the invention and many of its attendant advantages will be understood from the foregoing description, and it will be apparent that various changes may be made in the form, construction and arrangement of the parts, without departing from the spirit and scope of the invention or sacrificing any of its material advantages, the form hereinbefore described being merely a preferred embodiment thereof.

The components of the figures will first be discussed followed by how the components of the invention function together in a preferred embodiment.

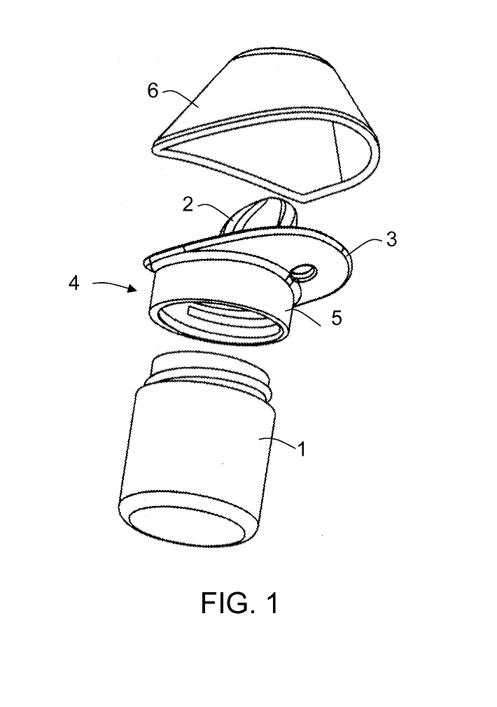

The invention provides the functionality of a nursing bottle and of a pacifier depending on how the parts are assembled. FIGS. 1 through 6 illustrate one possible embodiment of the invention as a feeding bottle. It comprises the following components:
1) A bottle 1 which is male-threaded on its top.
2) A nipple assembly 4 comprising a nipple 2 affixed to a cylindrical base 5 which is female-threaded at its bottom and configured to be screwed to the top of the bottle 1. The nipple assembly also includes a mouth-guard 3. The cylindrical base is configured in its bottom with a sealing ring to avoid leakage. The attachment mechanism between these elements needs to be very secure to prevent the parts from coming apart and posing a swallowing hazard to the child. For example the mouth-guard, cylindrical base, sealing ring and nipple could be manufactured as one single piece.
3) A protective cap 6 configured to fit on top of the nipple assembly 4. The outer edge of the protective cap 6 is shaped to conform to the outer edge of the mouth-guard 3.

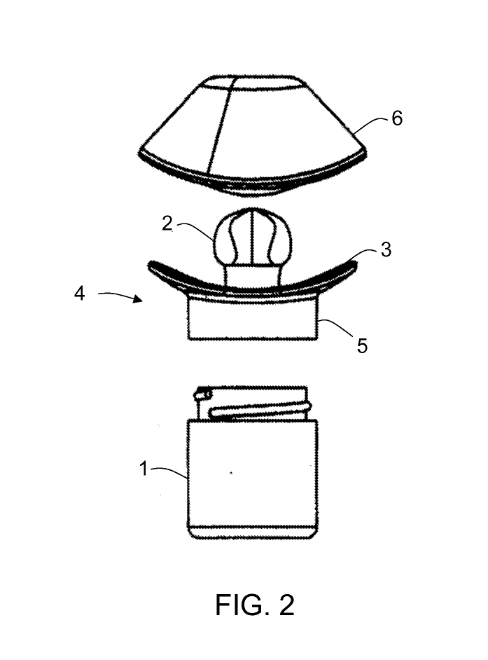

FIG. 2 shows the same components of FIG. 1, from a side view.

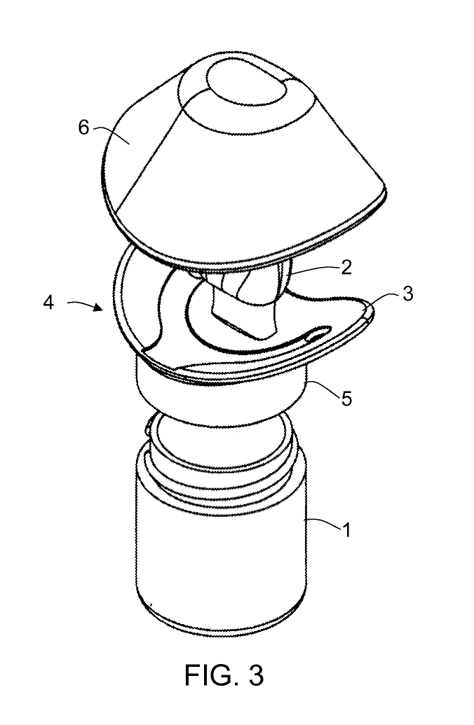

FIG. 3 illustrates the same components of FIG. 1, from a top perspective view.

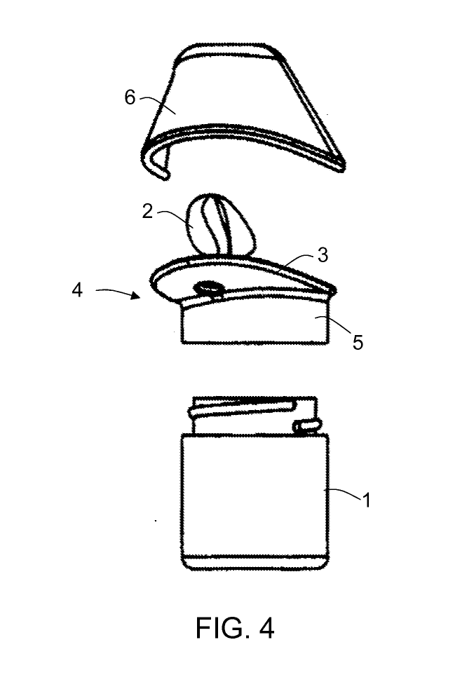

FIG. 4 illustrates the same components of FIG. 1, from an exploded side view, showing the device from a different angle than shown in FIG. 2.

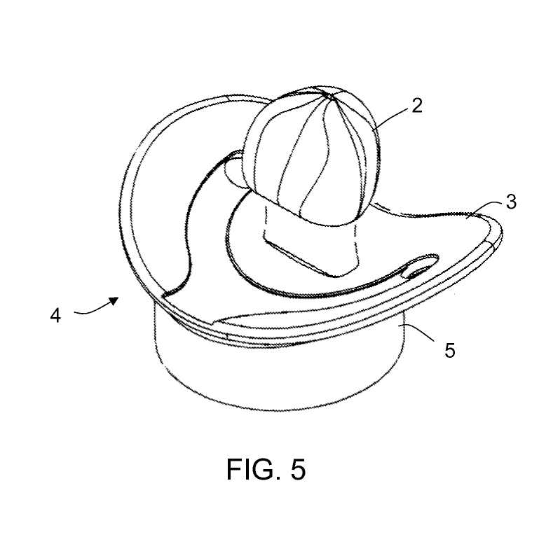

FIG. 5 shows a close up top perspective view of the nipple 2 in the nipple assembly 4. The holes permit air to pass through the windpipe in the event that the guard is ingested.

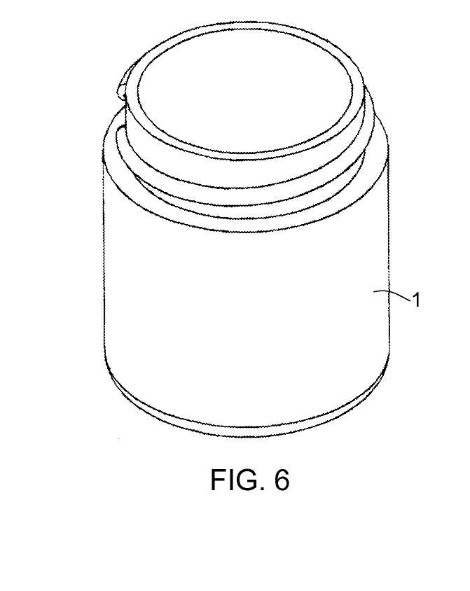

FIG. 6 is an enlarged perspective view of the bottle showing the preferred method of attachment of the bottle 1 to the nipple assembly 4. The figure shows the male-threaded top of the bottle.

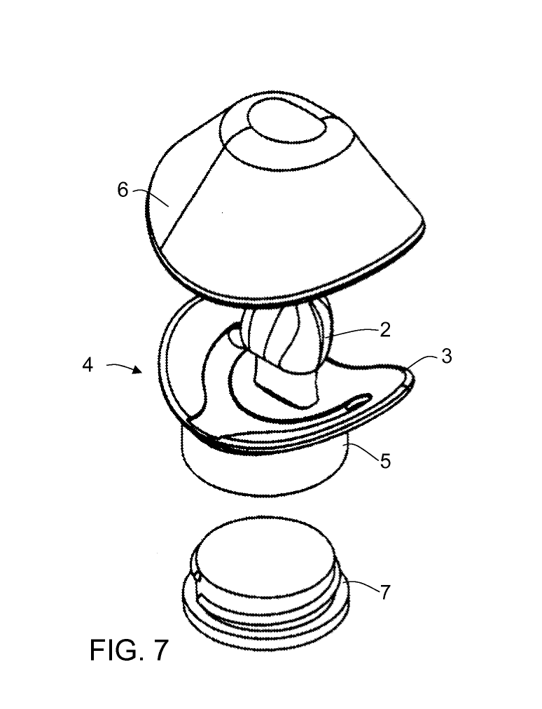

FIGS. 7 through 11 illustrate how the device shown in FIG. 1-6 can be converted to an infant pacifier. In FIG. 7, the bottle 1 is replaced by a plug 7 which is male threaded to conform to the female thread at the bottom of the nipple and mouth-guard assembly 4. The function of the plug is to stop air from entering the nipple 2 and be ingested by the child, when the device is used as a pacifier.

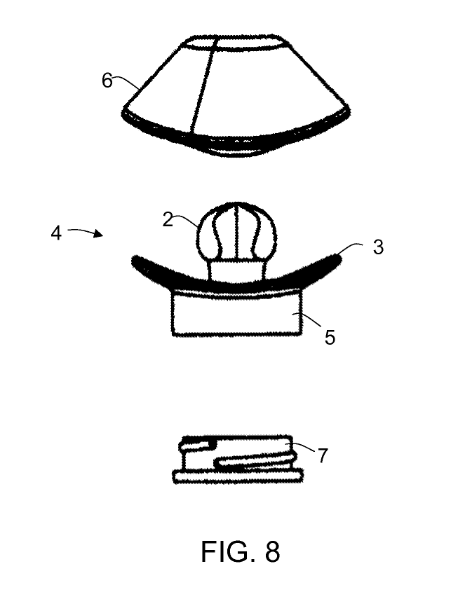

FIG. 8 illustrates the same components as seen in FIG. 7, from a side view.

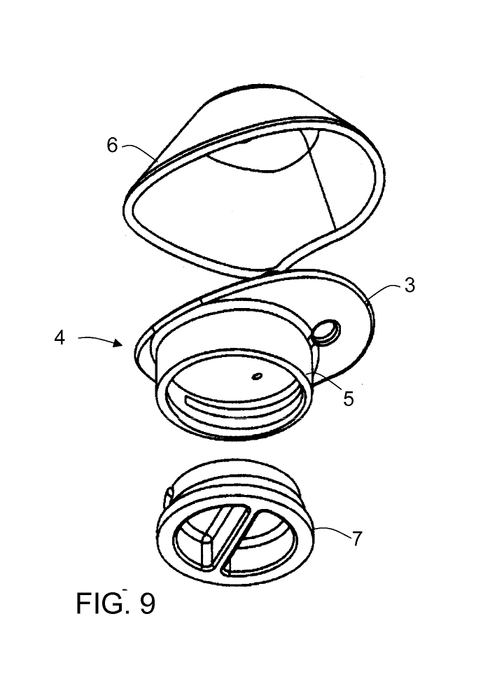

FIG. 9 illustrates the same components as seen in FIG. 7, from a top perspective view.

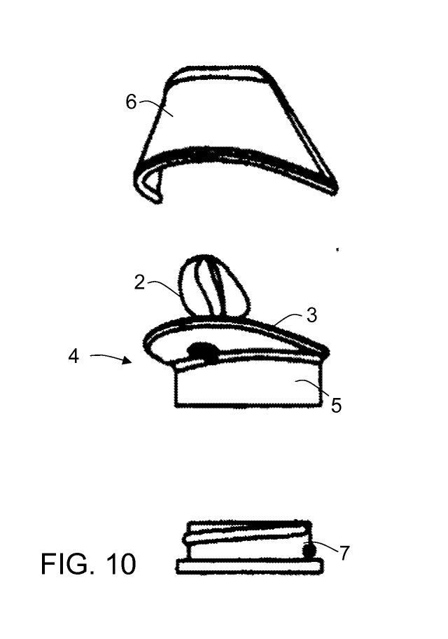

FIG. 10 illustrates the same components as seen in FIG. 9 from an exploded side view, showing the nipple assembly 4 from a different angle than shown in FIG. 7.

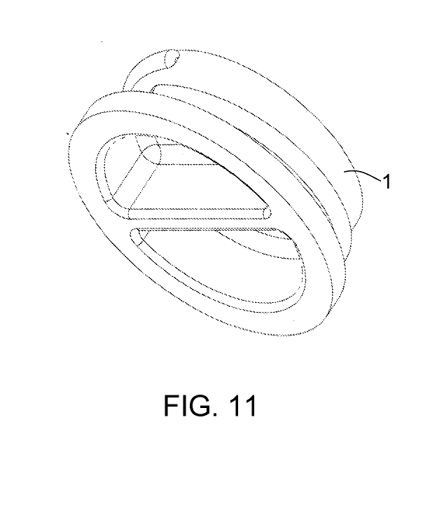

FIG. 11 illustrates the blocking plug 7.

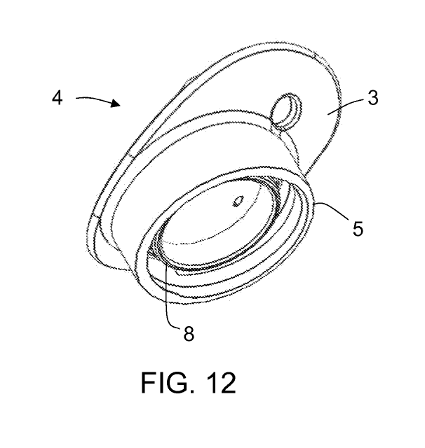

FIG. 12 shows the sealing ring 8 can be configured in the cylindrical base 5, to prevent liquid from leaking through the threads between the plug 7 and the nipple assembly 4.

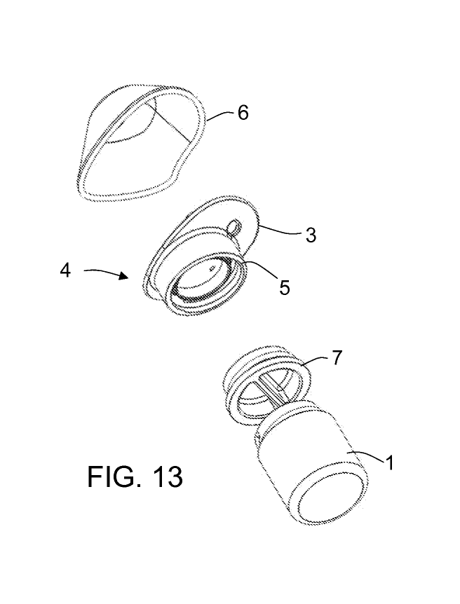

FIG. 13 shows the all the parts of the invention including the bottle 1, the nipple assembly 4, the protective cap 6 and the plug 7.

It is clear to those versed in the art that a regular sized feeding bottle can be attached to the nipple assembly thereby converting the device into a regular sized feeder.

While the above description contains many specificities, the reader should not construe these as limitations on the scope of the invention, but merely as exemplifications of preferred embodiments thereof. Those skilled in the art will envision many other possible variations within its scope. Accordingly, the reader is requested to determine the scope of the invention by the appended claims and their legal equivalents, and not by the examples which have been given.

What is claimed is:

1. An infant suckling device that can be configured as a feeding bottle or as a pacifier, comprising:
a) a bottle having its opening at its top end;
b) a plug;
c) a nipple assembly comprising:
i) a cylindrical base having a top end and a bottom end, said cylindrical base configured at its said bottom end with a sealing ring and furthermore configured at its bottom to be attached to said opening of said bottle or to said plug;
ii) a nipple attached to said top end of said cylindrical base, and in fluid communication through said cylindrical base with said bottle or said plug;
iii) a mouth-guard;
said suckling device operating as a feeder when said cylindrical base is attached to said bottle and said bottle is full of nutrient, and said suckling device operating as a pacifier when said cylindrical base is stopped up by said plug.

2. The suckling device of claim 1 wherein said cylindrical base includes a female thread at its said bottom end, said bottle includes a male thread on its said top end, and said plug also includes a male thread on its outer surface, said female thread matching said male threads, thereby allowing said bottle or said plug to be attached to said cylindrical base.

3. The suckling device of claim 1 also comprising a protective cap configured to fit on top of said nipple assembly.

4. The suckling device of claim 1 wherein the capacity of said bottle ranges from one ounce to two ounces.

5. A method of feeding or pacifying an infant, said method making use of device of claim 1 and comprising:
a) if said infant is to be fed, then filling said bottle with nutrient, attaching said bottle to said nipple assembly and administrating said suckling device to said infant; and
b) if said infant is to be pacified, then attaching said plug to said nipple assembly and administrating said suckling device to said infant.

6. The method of claim 5 wherein said infant is four months or younger.
